(19) United States
(12) Patent Application Publication
(10) Pub. No.: US 2025/0132405 A1
(43) Pub. Date: Apr. 24, 2025

(54) BATTERY SYSTEM, MANAGEMENT METHOD FOR THE SAME, AND BATTERY MANAGEMENT SYSTEM

(71) Applicant: RENOGY New Energy Co., Ltd., Suzhou City (CN)

(72) Inventor: Chengcheng HUANG, Suzhou City (CN)

(21) Appl. No.: 18/987,209

(22) Filed: Dec. 19, 2024

(30) Foreign Application Priority Data
Oct. 20, 2023 (CN) 202311361116.3

(51) Int. Cl. H01M 10/42; H01M 10/48; H01M 50/583

(52) U.S. Cl. CPC H01M 10/425; H01M 10/4221; H01M 10/482; H01M 50/583; H01M 2010/4271; H01M 2010/4278; H01M 2200/103

(57) ABSTRACT

A battery system according to the present disclosure includes a control host and multiple battery packs electrically connected to each other, and each battery pack is communicatively connected to the control host. Each battery pack includes a cell module, an anti-reverse module, a physical interface, and a detection module. The cell module is configured to be connected to the physical interface through the anti-reverse module, and the physical interfaces of the multiple battery packs are connected to each other. The detection module is configured to determine a voltage difference detection signal representing the voltage difference between the physical interface and the cell module. The control host is configured to determine a series-parallel connection configuration of all the battery packs in the battery system according to the voltage difference detection signal of each battery pack.

### CROSS-REFERENCE TO RELATED APPLICATION

The present application claims priority to Chinese Patent Application No. 2023113611163, filed with the China National Intellectual Property Administration (CNIPA) on Oct. 20, 2023, the disclosure of which is incorporated herein by reference in its entirety.

### TECHNICAL FIELD

Embodiments of the present disclosure relate to the technical field of battery energy storage and, in particular, to a battery system, a management method for the same, and a battery management system.

### BACKGROUND

In the field of energy storage, to enable an energy storage system to obtain a desired battery capacity or system voltage, multiple modular battery packs are usually connected in series, in parallel or both to form the energy storage system. Each modular battery pack has a nominal voltage and capacity. The series connection of the multiple battery packs may increase the voltage of the energy storage system while the capacity of the energy storage system remains unchanged. The parallel connection of the multiple battery packs may increase the capacity of the energy storage system while the voltage of the energy storage system remains unchanged.

However, since each battery pack is usually designed according to the same software and hardware solution, and battery pack manufacturers are not necessarily aware of the series-parallel connection configuration of the battery system the users would perform after they purchase the battery packs. The battery manufacturers cannot effectively design and manage the battery systems formed after the series-parallel connection, which poses a challenge to the design of the battery pack.

### SUMMARY

Embodiments of the present disclosure provide a battery system, a management method for the same, and a battery management system to automatically identify a series-parallel connection configuration of the battery system so that a control host can effectively manage the battery system according to the connection configuration.

Thus, in a first aspect, an embodiment of the present disclosure provides a battery system. The battery system includes a control host and a plurality of battery packs electrically connected to each other, where each battery pack of the plurality of battery packs is communicatively connected to the control host. Each battery pack includes a cell module, an anti-reverse module, a physical interface, and a detection module. The cell module is configured to be connected to the physical interface through the anti-reverse module, and the physical interfaces of the plurality of battery packs are connected to each other. The detection module is configured to determine a voltage difference detection signal representing a voltage difference between the physical interface and the cell module. The control host is configured to determine a series-parallel connection configuration of all the battery packs in the battery system according to the voltage difference detection signal of each battery pack.

Optionally, each battery pack further includes a communication module, and the control host performs communication with the communication module of each battery pack to acquire the voltage difference detection signal.

Optionally, the communication module is a wired communication module connected to the physical interface.

Optionally, each battery pack further includes a control module. The detection module includes a proportional arithmetic unit and a sampling unit, where an input terminal of the proportional arithmetic unit is connected to the physical interface and the cell module and configured to output a corresponding output voltage signal according to a voltage difference between the physical interface and a positive terminal of the cell module or a negative terminal of the cell module. An input terminal of the sampling unit is connected to an output terminal of the proportional arithmetic unit and configured to sample the output voltage signal and output the voltage difference detection signal to the control module.

Optionally, the control host is further configured to acquire device identification information of each battery pack and output the series-parallel connection configuration of all the battery packs in the battery system and the device identification information of each battery pack.

Optionally, each battery pack further includes a protection module, and the cell module is connected to the anti-reverse module through the protection module. Optionally, the protection module includes a fuse and/or a voltage follower.

Optionally, the anti-reverse module includes a diode, where a positive terminal of the diode is connected to the cell module, and a negative terminal of the diode is connected to the physical interface and the detection module separately.

In a second aspect, an embodiment of the present disclosure further provides a management method for a battery system, where the battery system includes a control host and a plurality of battery packs electrically connected to each other, where each battery pack of the plurality of battery packs is communicatively connected to the control host. Each battery pack includes a cell module, an anti-reverse module, a physical interface, and a detection module. The cell module is connected to the physical interface through the anti-reverse module, and physical interfaces of the plurality of battery packs are connected to each other. The detection module is configured to determine a voltage difference detection signal representing a voltage difference between the physical interface and the cell module.

The method includes the steps below: acquiring the voltage difference detection signal of each battery pack; and determining a series-parallel connection configuration of the plurality of battery packs in the battery system according to the voltage difference detection signal.

In a third aspect, an embodiment of the present disclosure further provides a battery management system including a memory and a processor, where the memory stores a computer program which, when executed by the processor, causes the processor to perform the management method provided in any embodiment of the present disclosure.

As described in the preceding, the battery pack disclosed in the embodiment of the present disclosure maps the voltage of each cell module to a respective physical interface through an anti-reverse module, and the physical interface of each battery pack is electrically connected, so that the voltage of the physical interface is equal to the voltage of the battery system. The detection module may acquire the voltage difference detection signal representing the voltage difference between the physical interface and the cell module so that the control host can determine the series-parallel connection configuration of all the battery packs in the battery system according to the voltage difference detection signal of each battery pack. Therefore, the battery system provided in this embodiment can automatically identify the series-parallel connection configuration of the multiple battery packs electrically connected to each other in the battery system so that the control host can effectively manage the battery system after the battery packs are series-parallel connected.

### BRIEF DESCRIPTION OF DRAWINGS

Drawings herein are incorporated into the Specification and constitute a part of the Specification, showing embodiments conforming to the present disclosure, and are used for explaining the principles of the present disclosure together with the Specification. To illustrate technical solutions of embodiments of the present disclosure more clearly, the drawings used in the description of the embodiments are briefly described below. Apparently, those of ordinary skill in the art may obtain other drawings based on these drawings on the premise that no creative work is done. These drawings and text descriptions are not intended to limit the scope of the concept of the present disclosure in any way but to illustrate the concept of the present disclosure for those skilled in the art by referring to specific embodiments.

FIG. 1 is a diagram illustrating the structure of a battery system according to an embodiment of the present disclosure.

FIG. 2 is a diagram illustrating the structure of another battery system according to an embodiment of the present disclosure.

FIG. 3 is a diagram illustrating the structure of another battery system according to an embodiment of the present disclosure.

FIG. 4 is a diagram illustrating the structure of another battery system according to an embodiment of the present disclosure.

FIG. 5 is a diagram illustrating the structure of another battery system according to an embodiment of the present disclosure.

FIG. 6 is a diagram illustrating the partial structure of another battery system according to an embodiment of the present disclosure.

FIG. 7 is a diagram illustrating the partial structure of another battery system according to an embodiment of the present disclosure.

FIG. 8 is a diagram illustrating the partial structure of another battery system according to an embodiment of the present disclosure.

FIG. 9 is a flowchart of a management method for a battery system according to an embodiment of the present disclosure.

FIG. 10 is a flowchart of another management method for a battery system according to an embodiment of the present disclosure.

FIG. 11 is an exemplary battery system according to an embodiment of the present disclosure.

### DETAILED DESCRIPTION

Example embodiments are described in detail herein, examples of which are shown in the drawings. When the description below refers to the drawings, the same numerals in different drawings represent the same or similar elements unless otherwise expressed. Implementations described in example embodiments below do not represent all implementations consistent with the present disclosure. Conversely, these implementations are only examples of an apparatus and method that are consistent with some aspects of the present disclosure as detailed in the appended claims.

It is to be noted that as used herein, the term “comprising”, “including” or any other variant thereof is intended to encompass a non-exclusive inclusion so that a process, method, article or apparatus that includes a series of elements not only includes the expressly listed elements but also includes other elements that are not expressly listed or are inherent to such a process, method, article or apparatus. In the absence of more restrictions, the elements defined by the statement “including a . . . ” do not exclude the presence of additional identical elements in the process, method, article or apparatus that includes the elements. It is to be further understood that as used herein, the singular forms such as “a”, “one” and “the” are intended to also include plural forms, unless there is an opposite indication in the context. Furthermore, as used herein, the terms such as “or”, “and/or”, “include at least one of the following” may be interpreted as inclusive or mean any one or any combination. Only when the combination of elements, functions, steps or operations is inherently mutually exclusive in some way, the exception of this definition occurs.

It is to be understood that though the terms such as “first”, “second”, and “third” may be used herein for describing various parameters or modules, these parameters or modules should not be limited to these terms. These terms are only used for distinguishing parameters or modules of the same type from each other. For example, without departing from the scope of the present disclosure, a first parameter may also be referred to as a second parameter, and similarly, the second parameter may also be referred to as the first parameter. Depending on the context, as used herein, the word “if” may be interpreted as “when”, “in response to determining”, or “in response to detecting”. Similarly, depending on the context, the phrase “if it is determined” or “if it is detected (stated conditions or events)” may be interpreted as “when it is determined” or “in response to determining”; or “when it is detected (stated conditions or events)” or “in response to detecting (stated conditions or events)”. In addition, components, features, and elements with the same names in different embodiments of the present disclosure may have the same meaning or may have different meanings, and the specific meanings thereof need to be determined by the explanation in a specific embodiment or further combined with the context in a specific embodiment.

It is to be understood that though various steps in the flowchart of embodiments of the present disclosure are illustrated sequentially as indicated by arrows, these steps are not necessarily performed sequentially in the sequence indicated by the arrows. Unless expressly stated herein, there is no strict limitation to the sequence in which the steps are performed, and the steps may be performed in other sequences. Moreover, at least part of the steps in the figures may include multiple sub-steps or multiple stages. These sub-steps or these stages are not necessarily performed at the same time, but may be performed at different times. These sub-steps or these stages are also not necessarily performed sequentially, but may take turns with at least part of sub-steps or stages of other steps, or may be performed alternately with at least part of sub-steps or stages of other steps.

It is to be understood that the embodiments described herein are intended to explain the present disclosure and not to limit the scope of claims of the present disclosure. To enhance the description of the technical effects of the embodiments of the present disclosure, several disadvantages of existing lithium battery system solutions are listed below.
1) In a certain implementation, each modular battery pack is designed to only support parallel connection in a lithium battery system. A customer selects battery packs with appropriate voltage levels for parallel connection according to actual application scenarios. In this implementation, battery packs can only be used in parallel connection and cannot be connected in series to form a battery system with different system voltages, which limits the application scenarios of the battery packs.
2) In a certain implementation, each modular battery pack is designed according to the requirements of a lithium battery system solution with a specific series-parallel connection configuration, and the customer directly purchases the final system solution for use. In this implementation, the customer's freedom in building a battery system connected in series and parallel is sacrificed. Once the system solution is purchased, the series-parallel connection configuration in the system cannot be changed.
3) In a certain implementation, the battery pack design solution may support series-parallel connection. After forming a battery system, the user needs to manually input the series-parallel connection solution of the battery system into the controller. In this solution, the battery system cannot automatically identify the series-parallel connection configuration between battery packs. The user needs to manually configure and input the battery system so that the battery system can be accurately managed and controlled. This solution not only is cumbersome, but also places a high requirement on the user's expertise, and not all users can satisfy this requirement.

In view of the preceding situation, this solution provides a battery system that can automatically identify the series-parallel connection configuration between multiple battery packs in the battery system. The battery system provided in this solution is preferably composed of several battery packs with the same or similar nominal voltages (rated voltages). For example, using lithium iron phosphate battery packs as an example, the voltage of each battery pack is selected to be 12.8 V.

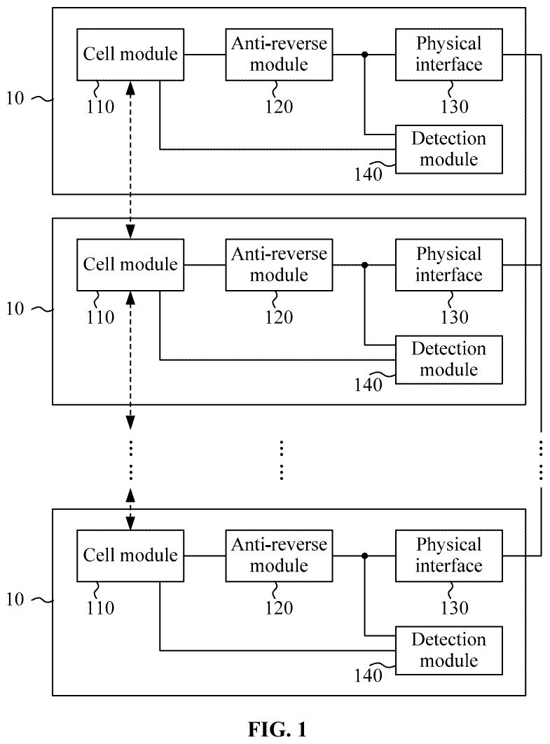

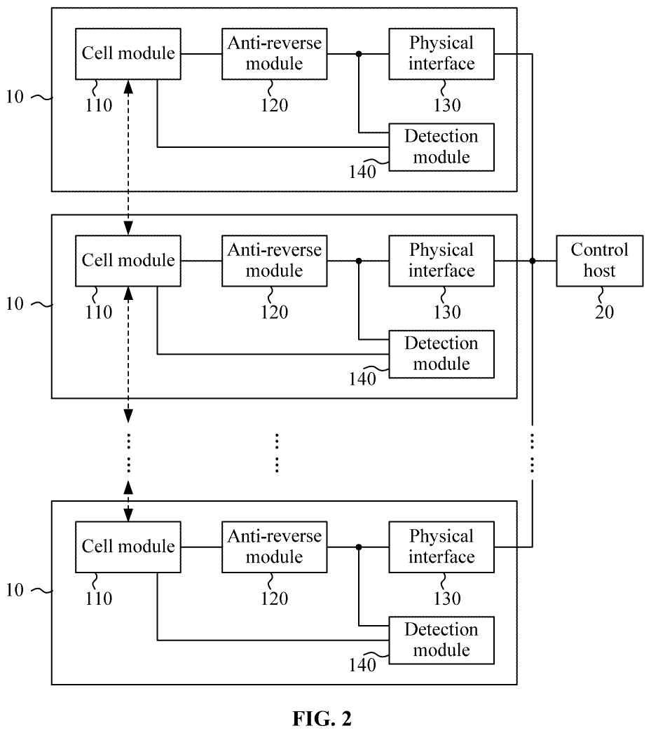

FIG. 1 is a diagram illustrating the structure of a battery system according to this embodiment. FIG. 2 is a diagram illustrating the structure of another battery system according to this embodiment. As shown in FIGS. 1 and 2, the battery system includes multiple battery packs 10 electrically connected to each other. Each battery pack of the multiple battery packs is communicatively connected to the control host 20. Each battery pack 10 includes a cell module 110, an anti-reverse module 120, a physical interface 130, and a detection module 140. The cell module 110 is configured to be connected to the physical interface 130 through the anti-reverse module 120, and the physical interfaces 130 of the multiple battery packs 10 are connected to each other. The detection module 140 is configured to determine a voltage difference detection signal representing the voltage difference between the physical interface 130 and the cell module 110. The control host 20 is configured to determine a series-parallel connection configuration of all the battery packs 10 in the battery system according to the voltage difference detection signal of each battery pack 10.

As an information processing center of the battery system, the control host 20 may perform wired communication (such as RS-485 communication or CAN communication) or wireless communication (such as Bluetooth communication, Bluetooth Mesh communication, ZigBee communication, or Wi-Fi communication) with each battery pack 10 to acquire running information of each battery pack 10 so as to determine the series-parallel connection configuration of all the battery packs 10 in the entire battery system. The control host 20 may be an additionally disposed smart terminal (such as a smartphone, a tablet computer, or a computer) or a monitoring host (such as a monitoring host computer of the battery system), or a battery pack 10 may also be selected from the battery system as the control host through a host competition strategy. Exemplarily, the control host 20 in FIG. 1 is any battery pack 10 in the battery system. For example, the first battery pack 10 may be used as the control host 20 of the entire battery system, and the battery pack 10 as the host may perform wired communication with the remaining battery packs 10 to acquire running information of the multiple battery packs 10. In an optional embodiment shown in FIG. 2, the control host 20 is additionally disposed independent of each battery pack and may perform wired or wireless communication with each battery pack 10 of the battery system to acquire the running information of each battery pack 10.

Specifically, the cell module 110 is connected to the physical interface 130 through the anti-reverse module 120, the physical interfaces 130 of the multiple battery packs 10 are electrically connected to each other, and the detection module 140 is connected to a connection wire between the physical interface 130 and the anti-reverse module 120 and further connected to the cell module 110. The cell module 110 of the battery pack 10 may store electrical power. The anti-reverse module 120 may map the potential of a positive terminal of the cell module 110 or the potential of a negative terminal of the cell module 110 to the physical interface 130 and prevent a current flowing between cell modules 110 of different battery packs 10. The detection module 140 may determine the voltage difference detection signal representing the voltage difference between the physical interface 130 and the cell module 110. The physical interface 130 is an interface communicating with each battery pack 10 and may be a communication port such as RJ45 or an aviation plug. Therefore, the physical interfaces 130 can not only achieve the communication interconnection between the multiple battery packs but also raise the voltages at the physical interfaces 130 to the same level since all the physical interfaces 130 of battery packs 10 are connected together. When communication is performed between the multiple battery packs 10 of the battery system through the physical interfaces 130, a communication wire may be a twisted-pair cable with a plug, and the cable includes a wire connected to the anti-reverse module 120 and wires for communication. The communication port of each battery pack is multiplexing so that each battery pack 10 does not require an extra physical interface, making the structure of each battery pack 10 simpler and the wiring of each battery pack 10 more convenient for the user.

According to the preceding connection relationship, the working process of the battery system includes that the detection module 140 acquires the voltage difference detection signal of each battery pack 10 and that the control host 20 may determine the series-parallel connection configuration of all the battery packs 10 in the battery system according to the voltage difference detection signal detected by each battery pack and the voltage calculation principle of a series-parallel connection configuration.

Specifically, in the battery system provided in the embodiment of the present disclosure, the cell module 110 may include several single cells connected in series, or in parallel, or in the both, to store and release electric power. The positive terminal of the cell module 110 or the negative terminal of the cell module 110 can be connected to the anti-reverse module 120 so that the potential of the positive terminal of the cell module 110 or the potential of the negative terminal of the cell module 110 is mapped to the physical interface 130. Moreover, due to the unidirectional conductivity of the anti-reverse module 120, even if the physical interfaces of the multiple battery packs are connected to each other, the multiple battery packs are not short-circuited.

The physical interfaces 130 of the multiple battery packs 10 are connected to each other using connection wires, so the voltages at the physical interfaces 130 of the multiple battery packs are at the same level. According to different connection configurations between the cell module 110 and the anti-reverse module 120, the voltages at the physical interface 130 are also different. Specifically, if the positive terminal of the cell module 110 of each battery pack 10 is connected to the physical interface 130 through the anti-reverse module 120, the voltage at the physical interface 130 is equal to the system voltage of the entire battery system (the highest voltage after all the battery packs are connected in series, or in parallel, or in the both); if the negative terminal of the cell module 110 of each battery pack 10 is connected to the physical interface 130 through the anti-reverse module 120, the voltage at the physical interface 130 is equal to the difference between the system voltage of the entire battery system and the voltage of a single battery pack. For example, assuming that the nominal voltage of each battery pack 10 is 12.8 V, and several battery packs 10 form a battery system with a 4SnP (which means four packs in series and n (n≥1) pack(s) in parallel) connection configuration. If the positive terminal of the cell module 110 of each battery pack 10 is connected to the physical interface 130 through the anti-reverse module 120, the voltage at the physical interface 130 is equal to the system voltage of the entire battery system, that is, 4*12.8 V=51.2 V. If the negative terminal of the cell module 110 of each battery pack 10 is connected to the physical interface 130 through the anti-reverse module 120, the voltage at the physical interface 130 is equal to the difference between the system voltage of the entire battery system and the voltage of the single battery pack, that is, 3*12.8 V=38.4 V. For another example, assuming that the nominal voltage of each battery pack 10 is 12.8 V, and several battery packs 10 form a battery system with n (n≥1) packs in parallel connection configuration. If the positive terminal of the cell module 110 of each battery pack 10 is connected to the physical interface 130 through the anti-reverse module 120, the voltage at the physical interface 130 is equal to the system voltage of the entire battery system, that is, 12.8 V. If the negative terminal of the cell module 110 of each battery pack 10 is connected to the physical interface 130 through the anti-reverse module 120, the voltage at the physical interface 130 is equal to the difference between the system voltage of the entire battery system and the voltage of the single battery pack, that is, 0 V. It is to be noted that in actual application scenarios, the actual voltage of each battery pack 10 varies within a certain voltage range with the difference in the remaining power, so the voltage at the physical interface 130 is not exactly equal to an integer multiple of the nominal voltage of the single battery pack 10 necessarily. When it is necessary to actually sample and acquire the voltage at the physical interface 130, the sampled value may be divided by the nominal voltage of the single battery pack and rounded to the nearest integer, and then the rounded value is multiplied by the nominal voltage of the single battery pack to infer the theoretical voltage value of the physical interface 130. A voltage threshold range may also be configured to compare with the sampled voltage value to determine whether the sampled value satisfies the requirement of the threshold range.

Further, after the battery system is configured, the voltage of the cell module 110 of each battery pack 10 is also determined accordingly. Therefore, each battery pack 10 is further provided with the detection module 140, and the detection module 140 is configured to determine the voltage difference detection signal representing the voltage difference between the physical interface 130 and the cell module 110. According to the voltage calculation principle of the series-parallel connection configuration (connecting in series results in voltage add up, connecting in parallel results in constant voltage), the voltage difference between the physical interface 130 of each battery pack 10 and the positive terminal of the cell module 110 of each battery pack 10 or the negative terminal of the cell module 110 of each battery pack 10 is detected so that the series-parallel position of each battery pack 10 in the entire battery system can be identified.

The control host 20 may be communicatively connected to each battery pack 10 to acquire the voltage difference detection signal detected by the detection module 140 of each battery pack, thereby determining the series-parallel relationship between all the battery packs, that is, determining the series-parallel connection configuration of all the battery packs in the entire battery system. For example, assuming that the nominal voltage of each battery pack 10 is 12.8 V, and the several battery packs 10 form the battery system with a 4SnP (n≥1) connection configuration. Assuming that the positive terminal of the cell module 110 of each battery pack 10 is connected to the physical interface 130 through the anti-reverse module 120, the voltage at the physical interface 130 is equal to the system voltage of the entire battery system, that is, 4*12.8 V=51.2 V. Further, the voltage of the negative terminal of the cell module of a battery pack at a first series position should be 0 V, and the voltage of the positive terminal of the cell module of the battery pack at the first series position should be 12.8 V. The voltage of the negative terminal of the cell module of a battery pack at a second series position should be 12.8 V, and the voltage of the positive terminal of the cell module of the battery pack at the second series position should be 25.6 V. The voltage of the negative terminal of the cell module of a battery pack at a third series position should be 25.6 V, and the voltage of the positive terminal of the cell module of the battery pack at the third series position should be 38.4 V. The voltage of the negative terminal of the cell module of a battery pack at a fourth series position should be 38.4 V, and the voltage of the positive terminal of the cell module of the battery pack at the fourth series position should be 51.2 V. Therefore, if the detection module 140 detects that the voltage difference between the physical interface 130 of the battery pack at which the detection module is located and the negative terminal of the cell module 110 of the battery pack at which the detection module is located is 51.2 V, it means that the battery pack 10 is at the first series position of the entire battery system. If the detection module detects that the voltage difference between the physical interface 130 of the battery pack at which the detection module is located and the negative terminal of the cell module 110 of the battery pack at which the detection module is located is 38.4 V, it means that the battery pack 10 is at the second series position of the entire battery system. If the detection module detects that the voltage difference between the physical interface 130 of the battery pack at which the detection module is located and the negative terminal of the cell module 110 of the battery pack at which the detection module is located is 25.6 V, it means that the battery pack 10 is at the third series position of the entire battery system. If the detection module detects that the voltage difference between the physical interface 130 of the battery pack at which the detection module is located and the negative terminal of the cell module 110 of the battery pack at which the detection module is located is 12.8 V, it means that the battery pack 10 is at the fourth series position of the entire battery system. As a result, the control host 20 may acquire the voltage difference detection signal detected by each battery pack 10, thereby determining the position of each battery pack 10 in the battery system, that is, determining the series-parallel connection configuration of all the battery packs in the entire battery system.

For another example, assuming that the nominal voltage of each battery pack 10 is 12.8 V, and the several battery packs 10 form the battery system with n (n≥1) pack(s) parallel connection configuration. Assuming that the positive terminal of the cell module 110 of each battery pack 10 is connected to the physical interface 130 through the anti-reverse module 120, the voltage at the physical interface 130 is equal to the system voltage of the entire battery system, that is, 12.8 V. Further, the voltage of the positive terminal of the cell module of each battery pack should be 12.8 V, and the voltage of the negative terminal of the cell module of each battery pack should be 0 V. Therefore, if the control host 20 acquires that the voltage difference between the physical interface 130 of each battery pack and the negative terminal of the cell module 110 of each battery pack is 12.8 V, it may be determined that the battery system is a system with n packs parallel connection configuration, and n is the number of acquired voltage difference detection signals (that is, the number of battery packs; if the control host 20 itself is a battery pack, the control host needs to be taken into consideration).

FIG. 11 shows an exemplary battery system which includes four battery packs 10 connected in series. Each battery pack 10 may use rechargeable battery cells to form the cell module 110. Typical rechargeable battery cells may include a nickel-cadmium battery, a lead-acid battery, a nickel-metal hydride battery, a lithium-ion battery, and a lithium polymer battery.

Each battery pack 10 further has a housing, and the cell module 110 is disposed within the housing. The housing is also provided with a positive terminal 171 and a negative terminal 172. Terminals of adjacent battery packs are connected sequentially using a copper busbar 180, thereby forming the battery system in which the four battery packs are continuously connected in series. It is to be noted that the placement direction of a first battery pack and a third battery pack in FIG. 11 is opposite to the placement direction of a second battery pack and a fourth battery pack in FIG. 11. This staggered stacking placement can simplify the wiring process. The cell module 110 within the housing is coupled to the positive terminal 171 and the negative terminal 172 so as to be charged or discharged through the positive terminal 171 and the negative terminal 172.

The housing is further provided with the physical interface 130, and physical interfaces 130 of the four battery packs are connected sequentially. Typically, the physical interface 130 shown in FIG. 11 uses an aviation plug as a connection terminal, and each battery pack is provided with a LINK port and an UP port. The LINK port of the previous battery pack is connected to the UP port of the next battery pack, thereby forming a CAN communication connection between the four battery packs, and an unoccupied port may also be connected to a terminal resistor. Each port is provided with multiple pins. Each pin has a specific function and purpose, such as transmitting power, transmitting a CAN communication signal, or grounding. One of the pins is configured to be connected to the aforementioned anti-reverse module 120, and the anti-reverse module 120 is disposed on a printed circuit board within the housing of each battery pack. Therefore, when cables 190 are used for connecting the four battery packs 10, the physical interfaces 130 of the four battery packs 10 are connected to each other so that anti-reverse modules 120 of the four battery packs 10 can be connected together and at the same voltage level, and the value of the voltage level is equal to the system voltage value of the entire battery system.

Further, the printed circuit board within the housing of each battery pack is further provided with the detection module 140, and the detection module 140 is configured to determine the voltage difference detection signal representing the voltage difference between the physical interface 130 and the cell module 110. Specifically, the detection module 140 may use a voltage-dividing circuit to compare the difference between the two voltage values and obtain the voltage difference detection signal by sampling.

In this embodiment, the voltage of the cell module 110 is mapped to the physical interface 130 through the anti-reverse module 120 so that the detection module 140 can acquire the voltage difference detection signal representing the voltage difference between the physical interface 130 of each battery pack 10 and the cell module 110 of each battery pack, and the control host 20 can determine the series-parallel connection configuration of all the battery packs 10 in the battery system according to the voltage difference detection signal of each battery pack 10. Therefore, the battery system provided in this embodiment can automatically identify the series-parallel connection configuration of the multiple battery packs 10 electrically connected to each other in the battery system so that the control host 20 can effectively manage the battery system formed after the series-parallel connection.

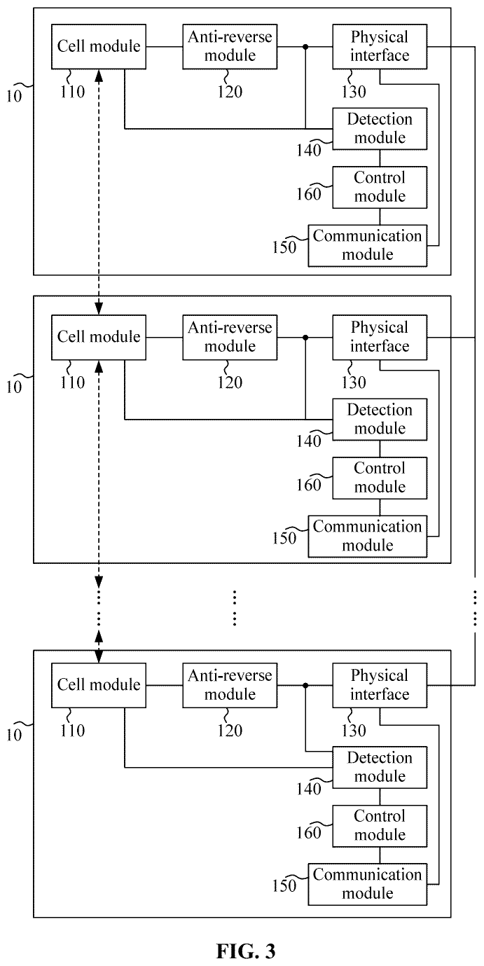

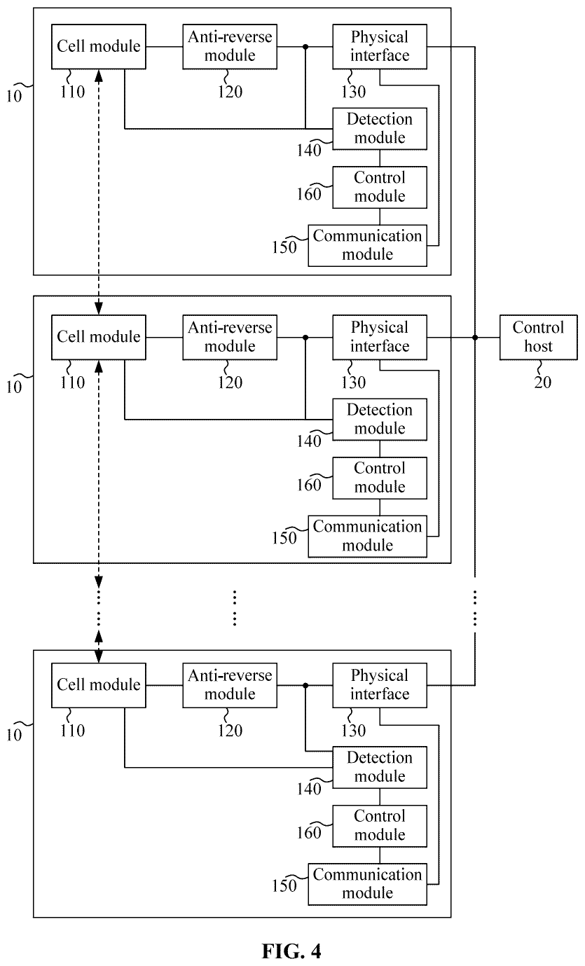

FIG. 3 is a diagram illustrating the structure of another battery system according to this embodiment. FIG. 4 is a diagram illustrating the structure of another battery system according to this embodiment. As shown in FIGS. 3 and 4, each battery pack 10 further includes a communication module 150, and the control host 20 performs communication with the communication module 150 of each battery pack 10 to acquire the voltage difference detection signal. Each battery pack 10 further includes a control module 160 which may be a battery management system of each battery pack 10. Specifically, the detection module 140 is connected to the control module 160 and may output the voltage difference detection signal to the control module 160. The control module 160 is connected to the communication module 150 and may send the voltage difference detection signal to the control host 20 through the communication module 150. If the communication module 150 is a wired communication module 150, the wired communication module 150 is connected to the physical interface 130 and performs communication with another battery pack and/or the control host 20 through the physical interface 130.

In FIG. 3, any battery pack 10 in the battery system serves as a control host, and the communication module 150 of the battery pack 10 serving as the control host is communicatively connected to the remaining battery packs 10 in the battery system through the physical interface 130, thereby acquiring the voltage difference detection signal of each battery pack 10 and determining the series-parallel connection configuration of all the battery packs 10 in the battery system. In FIG. 4, a peripheral device as the control host 20 is connected to the communication module 150 of each battery pack 10 through the physical interface 130 of each battery pack 10, thereby acquiring the voltage difference detection signal of each battery pack 10 and determining the series-parallel connection configuration of all the battery packs 10 in the battery system. Wired communication includes, but is not limited to, the RS-485 communication or the CAN communication.

If the communication module 150 is a wireless communication module, the wireless communication module directly performs wireless communication with the control host 20. The wireless communication includes, but is not limited to, Bluetooth communication, Bluetooth Mesh communication, ZigBee communication, or Wi-Fi communication.

Any battery pack 10 of the battery system serving as the control host 20 is used as an example in the following embodiment to elaborate the structure and working principle of the battery system in detail.

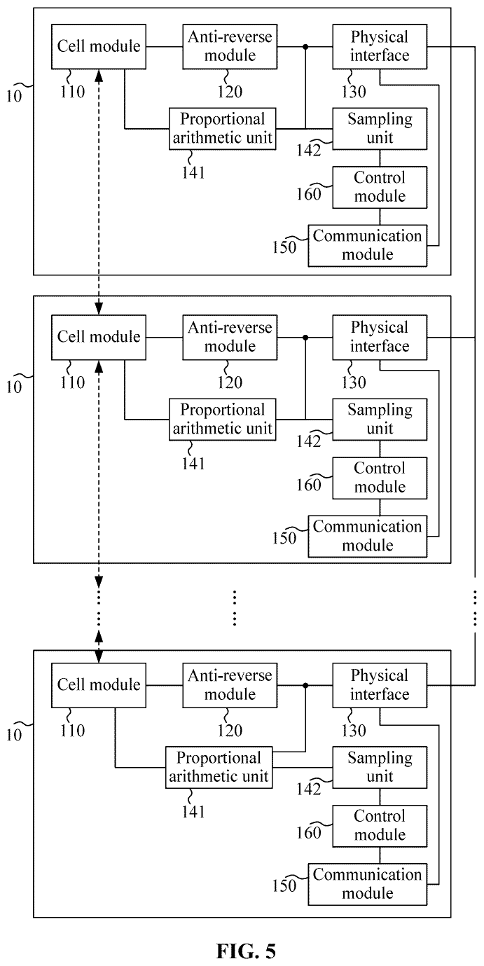

FIG. 5 is a diagram illustrating the structure of another battery system according to this embodiment. The detection module 140 includes a proportional arithmetic unit 141 and a sampling unit 142. The input terminal of the proportional arithmetic unit 141 is connected to the physical interface 130 and the anti-reverse module 120 and configured to output a corresponding output voltage signal according to the voltage difference between the physical interface 130 and the positive terminal of the cell module 110 or the negative terminal of the cell module 110. The input terminal of the sampling unit 142 is connected to the output terminal of the proportional arithmetic unit 141 and configured to sample the output voltage signal and output the voltage difference detection signal to the control module 160.

The proportional arithmetic unit 141 includes a difference proportional arithmetic circuit and may calculate the voltage difference between the physical interface 130 and the positive terminal of the cell module 110 or the negative terminal of the cell module 110, thereby outputting the output voltage signal corresponding to the voltage difference. The sampling unit 142 includes an ADC (Analog-to-Digital Converter) sampling circuit and may convert the output voltage signal outputted by the proportional arithmetic unit 141 into a suitable voltage difference detection signal received by a port of the control module 160 and output the voltage difference detection signal to the control module 160.

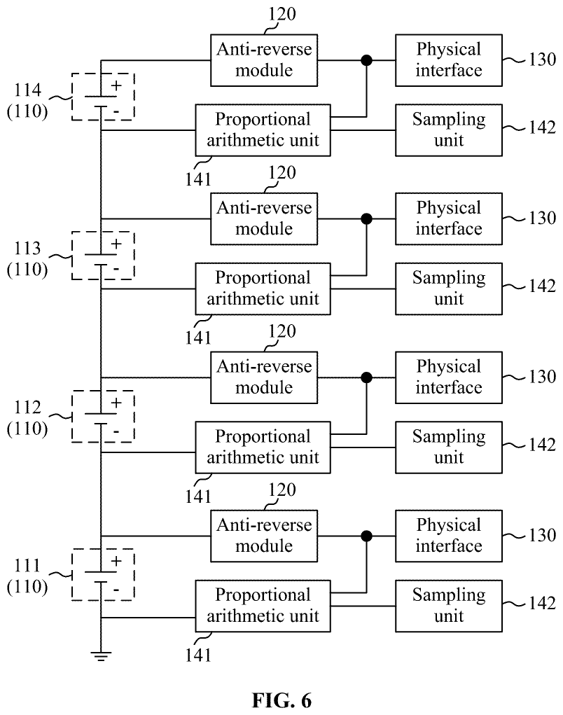

In an embodiment, FIG. 6 is a diagram illustrating the partial structure of another battery system according to this embodiment. In FIG. 6, the positive terminal of the cell module 110 is connected to the physical interface 130 through the anti-reverse module 120. A first input terminal of the proportional arithmetic unit 141 is connected to a connection wire between the anti-reverse module 120 and the physical interface 130, and a second input terminal of the proportional arithmetic unit 141 is connected to the negative terminal of the cell module 110. Therefore, the proportional arithmetic unit 141 may output the corresponding output voltage signal according to the voltage difference between the physical interface 130 and the negative terminal of the cell module 110. The output terminal of the proportional arithmetic unit 141 is connected to the input terminal of the sampling unit 142, and the sampling unit 142 may sample the output voltage signal output by the proportional arithmetic unit 141 and output the voltage difference detection signal to the control module 160.

Exemplarily, it is assumed that the voltage of each cell module 110 is 12.8 V. Since the anti-reverse module 120 has unidirectional conductivity, and all the physical interfaces 130 are connected by connection wires, the voltage at the physical interface 130 of each battery pack 10 is raised to the system voltage of the battery system, and the magnitude of the system voltage depends on the series-parallel relationship between the multiple battery packs. If the multiple battery packs are connected in parallel, the system voltage is 12.8 V. If the battery system has a 2SnP (n≥1) connection configuration, the system voltage is 25.6 V. If the battery system has a 3SnP (n≥1) connection configuration, the system voltage is 38.4 V. And if the battery system has a 4SnP (n≥1) connection configuration, the system voltage is 51.2 V, . . . , and so on. Using FIG. 6 as an example, FIG. 6 shows a battery system in which four battery packs are connected in series, so the system voltage is 51.2 V. Further, the sampling unit 142 connected to the cell module 111 outputs a voltage difference detection signal of 51.2 V, the sampling unit 142 connected to the cell module 112 outputs a voltage difference detection signal of 38.4 V, the sampling unit 142 connected to the cell module 113 outputs a voltage difference detection signal of 28.6 V, and the sampling unit 142 connected to the cell module 114 outputs a voltage difference detection signal of 12.8 V. Therefore, when the control host 20 acquires four different voltage difference detection signals, it may determine that the battery system is a system with four packs in series connection configuration.

In another embodiment, FIG. 7 is a diagram illustrating the partial structure of another battery system according to this embodiment. In FIG. 7, the negative terminal of the cell module 110 is connected to the physical interface 130 through the anti-reverse module 120, a first input terminal of the proportional arithmetic unit 141 is connected to a connection wire between the anti-reverse module 120 and the physical interface 130, and a second input terminal of the proportional arithmetic unit 141 is connected to the positive terminal of the cell module 110. Therefore, the proportional arithmetic unit 141 may output the corresponding output voltage signal according to the voltage difference between the physical interface 130 and the positive terminal of the cell module 110. The output terminal of the proportional arithmetic unit 141 is connected to the input terminal of the sampling unit 142, and the sampling unit 142 may sample the output voltage signal and output the voltage difference detection signal to the control module 160.

Exemplarily, it is assumed that the voltage of each cell module 110 is 12.8 V. Since the anti-reverse module 120 has unidirectional conductivity, and all the physical interfaces 130 are connected by connection wires, the voltage at the physical interface 130 of a physical port of each battery pack 10 is raised to the difference between the voltage of the battery system and the voltage of a single battery pack. Using FIG. 7 as an example, FIG. 7 shows a battery system in which four battery packs are connected in series, so the voltage at the physical interface 130 is 38.4 V. Further, the sampling unit 142 connected to the cell module 115 outputs a voltage difference detection signal of −12.8 V, the sampling unit 142 connected to the cell module 116 outputs a voltage difference detection signal of 0 V, the sampling unit 142 connected to the cell module 117 outputs a voltage difference detection signal of 12.8 V, and the sampling unit 142 connected to the cell module 118 outputs a voltage difference detection signal of 25.6 V. Therefore, when the control host 20 acquires four different voltage difference detection signals, it may determine that the battery system is a system with four packs in series connection configuration.

The voltage difference detection signals detected by the four battery packs in the series system should be different from each other and spaced apart from each other by the voltage value of one battery pack in steps. The voltage difference detection signal detected by each battery pack in the parallel system should be exactly the same. The control host may determine the series-parallel connection configuration of each battery pack in the battery system according to this principle. Conversely, if the voltage difference detection signals acquired by the control host do not meet the preceding principle, it means that the battery system is in an abnormal state, and an abnormal warning signal should be sent to remind the user to check the battery system.

Optionally, the control host 20 is further configured to acquire device identification information of each battery pack 10 and output the series-parallel connection configuration of all the battery packs 10 in the battery system and the device identification information of each battery pack 10.

The device identification information of each battery pack 10 includes a device SN code, a device address serial number, the address of the communication module 150, and the identification of the communication module. The control host 20 may output device identification information of battery packs 10 connected in series in each branch according to the device identification information of each battery pack 10 and the series-parallel connection configuration of all the battery packs 10 in the battery system. For example, the control host 20 may be a monitoring device with a display panel and display the series-parallel connection configuration of the entire battery system and the device identification information of a battery pack in each series group on the display panel so that the user can accurately position the series-parallel position of each battery pack according to the graphical information displayed by the control host 20 and thereby perform corresponding inspection and operation.

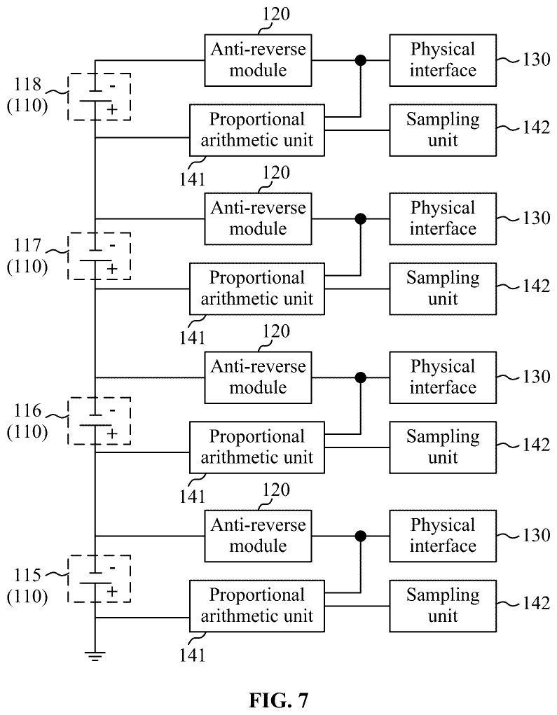

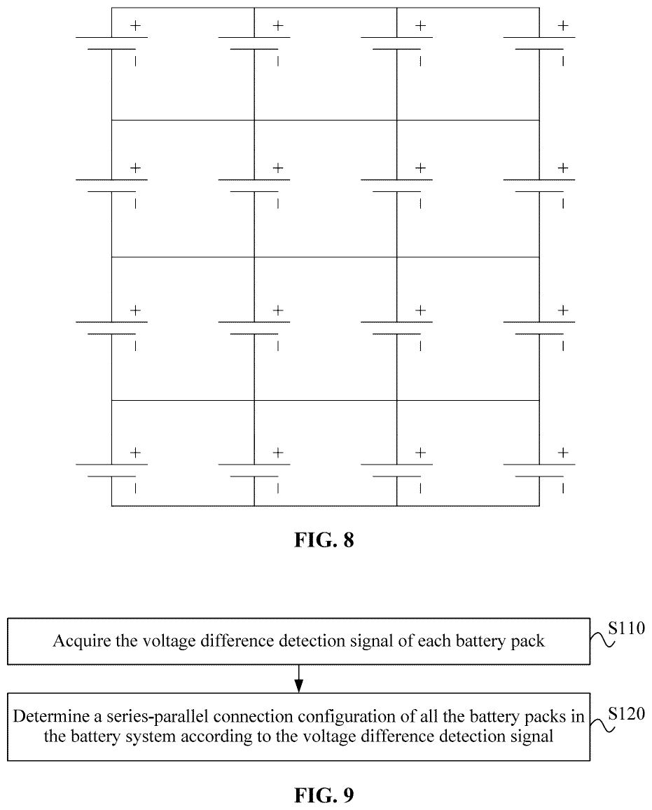

FIG. 8 is a diagram illustrating the partial structure of another battery system according to this embodiment. FIG. 8 shows a battery system in which 16 battery packs 10 are connected in 4S4P connection configuration. It is assumed that the positive terminal of the cell module 110 of each battery pack 10 is connected to the physical interface 130 through the anti-reverse module 120. The first input terminal of the proportional arithmetic unit 141 is connected to the connection wire between the anti-reverse module 120 and the physical interface 130, and the second input terminal of the proportional arithmetic unit 141 is connected to the negative terminal of the cell module 110.

Assuming that the voltage of the cell module 110 is 12.8 V, the voltage of the battery system is 51.2 V, and in this case, the control host 20 may collect voltages of 12.8 V, 25.6 V, 38.4 V and 51.2 V, among which battery packs 10 with the voltage of 12.8 V are in a first series branch, battery packs 10 with the voltage of 25.6 V are in a second series branch, battery packs 10 with the voltage of 38.4 V are in a third series branch, and battery packs 10 with the voltage of 51.2 V are in a fourth series branch. If the number of battery packs 10 in each series branch is different, or there is a deviation in the voltage values (for example, if the voltage value of 25.6 V is missing in the preceding example), the battery system should report an error or remind the user that the system connection manner is incorrect. It is also to be noted that in actual application scenarios, the actual voltage value of each battery pack 10 varies within a certain voltage range with the difference in the remaining power, so the voltage value collected by the detection module may not be exactly equal to an integer multiple of the nominal voltage of the single battery pack 10. In the actual processing process, the sampled value may be divided by the nominal voltage of the single battery pack and rounded to the nearest integer, and then the rounded value is multiplied by the nominal voltage of the single battery pack to infer the theoretical voltage value, thereby filtering out the impact brought by a deviation in the voltage value of each battery pack. A voltage threshold range may also be configured to compare with the sampled voltage value to determine whether the sampled value satisfies the requirement of the threshold range.

In addition, the control host 20 further acquires the device identification information of each battery pack 10 and may output or display the device identification information of the battery packs 10 connected in series in each branch according to the device identification information of each battery pack 10 and the series-parallel connection configuration of all the battery packs 10 in the battery system so that the user can check and operate a corresponding battery pack according to the device identification information.

Optionally, each battery pack 10 further includes a protection module, and the cell module 110 is connected to the anti-reverse module 120 through the protection module. Specifically, the protection module includes a fuse and/or a voltage follower.

When a circuit is short-circuited or severely overloaded, the fuse may quickly melt and cut off the circuit to prevent the circuit from being burned due to an over current.

The voltage follower has the characteristics of high input impedance and low output impedance. The voltage follower is equivalent to an open circuit for the previous-stage circuit; when the output impedance of the voltage follower is very low, the voltage follower is equivalent to a constant voltage source for the next-stage circuit. The output voltage of the voltage follower is not affected by the impedance of the next-stage circuit and has an isolation effect so that the front-stage circuit and the back-stage circuit cannot affect each other. Therefore, other terminals at the physical interface 130, especially communication terminals, can be protected from interference from a large current.

Optionally, the anti-reverse module 120 includes a diode. The positive terminal of the diode is connected to the cell module 110, and the negative terminal of the diode is connected to the physical interface 130 and the detection module 140 separately.

The diode has unidirectional conductivity, and the current can only flow from the positive terminal of the diode to the negative terminal of the diode. Therefore, the diode may map the potential of the positive terminal of the cell module 110 or the potential of the negative terminal of the cell module 110 to the physical interface 130 and prevent a circulation current between the cell modules 110 of the different battery packs 10.

FIG. 9 is a flowchart of a management method for a battery system according to an embodiment of the present disclosure. The battery system includes a control host and multiple battery packs electrically connected to each other, and each battery pack is communicatively connected to the control host. Each battery pack includes a cell module, an anti-reverse module, a physical interface, and a detection module. The cell module is connected to the physical interface through the anti-reverse module, and physical interfaces of the multiple battery packs are connected to each other. The detection module is configured to determine a voltage difference detection signal representing the voltage difference between the physical interface and the cell module.

Optionally, the management method may be performed by the control host, and the control host may be an additionally disposed smart terminal (such as a smartphone, a tablet computer, or a computer) or a monitoring host (such as a monitoring host computer of the battery system), or a battery pack may also be selected from the battery system as the control host through a host competition strategy.

As shown in FIG. 9, the management method for a battery system includes the steps below.

In S110, acquire the voltage difference detection signal of each battery pack.

The detection module of each battery pack may acquire the voltage difference detection signal of each battery pack, and the voltage difference detection signal refers to the voltage difference between the physical interface and the cell module. The control host may be communicatively connected to each battery pack to acquire the voltage difference detection signal detected by each battery pack.

In S120, determine a series-parallel connection configuration of the plurality of battery packs in the battery system according to the voltage difference detection signal.

The control host may determine the series-parallel connection configuration of all the battery packs in the battery system according to the pressure difference detection signal. The principle of determining the series-parallel connection configuration of all the battery packs in the battery system has been fully explained in the preceding embodiments of the battery system and thereby is not repeated herein.

In the management method for a battery system provided in the embodiments of the present disclosure, the voltage difference detection signal of each battery pack representing the voltage difference between the physical interface and the cell module is acquired so that the series-parallel connection configuration of all the battery packs in the battery system can be determined according to the voltage difference detection signal. Therefore, the battery system provided in this embodiment can automatically identify the series-parallel connection configuration of the multiple battery packs electrically connected to each other in the battery system so that the control host can effectively manage the battery system formed after the series-parallel connection.

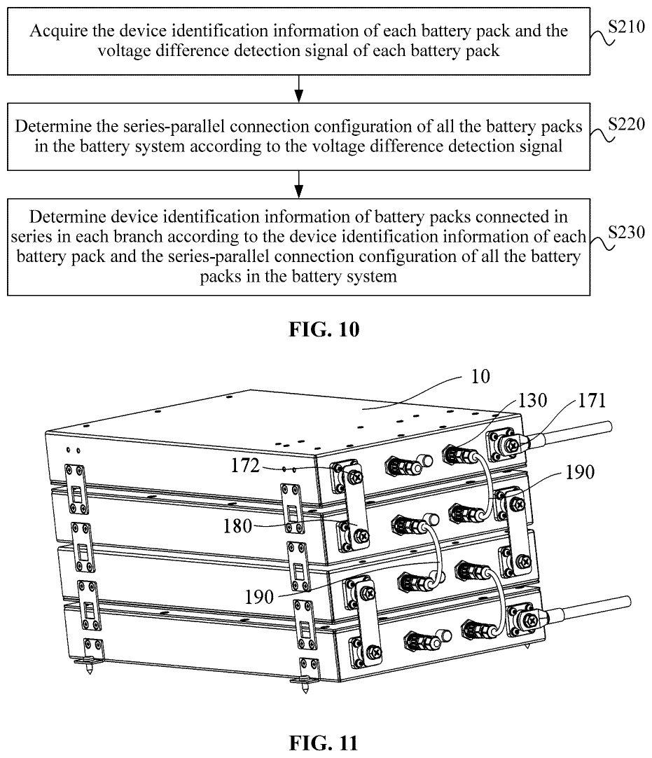

FIG. 10 is a flowchart of another management method for a battery system according to an embodiment of the present disclosure. The control host is further configured to acquire device identification information of each battery pack and output the series-parallel connection configuration of all the battery packs in the battery system and the device identification information of each battery pack.

As shown in FIG. 10, the management method for a battery system includes the steps below.

In S210, acquire the device identification information of each battery pack and the voltage difference detection signal of each battery pack.

In S220, determine the series-parallel connection configuration of all the battery packs in the battery system according to the voltage difference detection signal.

In S230, determine device identification information of battery packs connected in series in each branch according to the device identification information of each battery pack and the series-parallel connection configuration of all the battery packs in the battery system.

An embodiment of the present disclosure further provides a battery management system. The battery management system includes a memory and a processor. The memory stores a computer program which, when executed by the processor, causes the processor to perform the method provided in any embodiment of the present disclosure.

A computer storage medium of the embodiment of the present disclosure may use any combination of one or more computer-readable media. The computer-readable medium may be a computer-readable signal medium or a computer-readable storage medium. The computer-readable storage medium may be, but is not limited to, an electrical, magnetic, optical, electromagnetic, infrared or semiconductor system, apparatus or device, or any combination thereof. Examples (a non-exhaustive list) of the computer-readable storage medium include an electrical connection having one or more wires, a portable computer magnetic disk, a hard disk, a random-access memory (RAM), a read-only memory (ROM), an erasable programmable read-only memory (EPROM), a flash memory, an optical fiber, a portable compact disc read-only memory (CD-ROM), an optical storage device, a magnetic storage device, or any suitable combination thereof. In the present disclosure, the computer-readable storage medium may be any tangible medium including or storing a program that may be used by or in connection with an instruction execution system, apparatus, or device.

The serial numbers of the preceding embodiments of the present disclosure are for ease of description and do not indicate superiority and inferiority of the embodiments.

In the present disclosure, the same or similar terminology concepts, technical solutions and/or application scenario descriptions are generally described in detail only the first time they appear. When they appear again later, they are generally not repeated for the sake of brevity. When the technical solutions and other contents of the present disclosure are understood, for the same or similar terminology concepts, technical solutions and/or application scenario descriptions that are not described in detail later, reference may be made to the preceding related detailed descriptions.

In the present disclosure, the description of each embodiment has its own emphasis. For a part not described in detail or recorded in an embodiment, reference may be made to related descriptions of other embodiments.

The technical features of the technical solutions of the present disclosure may be combined in any manner. For brevity of description, all possible combinations of the technical features in the preceding embodiments are not described. However, as long as the combinations of these technical features do not conflict, such combinations are to be construed as being within the scope of the present disclosure.

From the description of the preceding embodiments, it is apparent to those skilled in the art that the method in the preceding embodiments may be implemented by software plus a necessary general-purpose hardware platform, or may certainly be implemented by hardware. However, the former is a preferred implementation mode in many cases. Based on this understanding, the technical solutions provided in the present disclosure substantially, or the part contributing to the existing art, may be embodied in the form of a software product. The computer software product is stored on a storage medium (such as an ROM/RAM, a magnetic disk or an optical disk) and includes several instructions for enabling a terminal device to perform the method according to each embodiment of the present disclosure.

The preceding embodiments are optional embodiments of the present disclosure and are not intended to limit the scope of the present disclosure. Any equivalent structural variations or equivalent process variations made on the basis of the Specification and the Drawings of the present disclosure, or direct or indirect utilization in other relevant technical fields all fall within the scope of the present disclosure.

What is claimed is:

1. A battery system, comprising a control host and a plurality of battery packs electrically connected to each other, wherein each battery pack of the plurality of battery packs is communicatively connected to the control host; and
each battery pack comprises a cell module, an anti-reverse module, a physical interface, and a detection module,
wherein the cell module is configured to be connected to the physical interface through the anti-reverse module, and the physical interfaces of the plurality of battery packs are connected to each other;
wherein the detection module is configured to determine a voltage difference detection signal representing a voltage difference between the physical interface and the cell module; and
wherein the control host is configured to determine a series-parallel connection configuration of the plurality of battery packs in the battery system according to the voltage difference detection signal of each battery pack.

2. The battery system of claim 1, wherein each battery pack further comprises a communication module, and the control host performs communication with the communication module of each battery pack to acquire the voltage difference detection signal.

3. The battery system of claim 2, wherein the communication module is a wired communication module connected to the physical interface.

4. The battery system of claim 1, wherein each battery pack further comprises a control module; and
the detection module comprises a proportional arithmetic unit and a sampling unit, wherein an input terminal of the proportional arithmetic unit is connected to the physical interface and the cell module and configured to output an output voltage signal according to a voltage difference between the physical interface and a positive terminal of the cell module or a negative terminal of the cell module; and
wherein an input terminal of the sampling unit is connected to an output terminal of the proportional arithmetic unit and configured to sample the output voltage signal and output the voltage difference detection signal to the control module.

5. The battery system of claim 1, wherein the control host is further configured to acquire device identification information of each battery pack and output the series-parallel connection configuration of the plurality of battery packs in the battery system and the device identification information of each battery pack.

6. The battery system of claim 1, wherein each battery pack further comprises a protection module, and the cell module is connected to the anti-reverse module through the protection module.

7. The battery system of claim 6, wherein the protection module comprises at least one of a fuse or a voltage follower.

8. The battery system of claim 1, wherein the anti-reverse module comprises a diode, wherein a positive terminal of the diode is connected to the cell module, and a negative terminal of the diode is connected to the physical interface and the detection module separately.

9. A battery pack, comprising a cell module, an anti-reverse module, a physical interface, a detection module, and a communication module;
wherein the cell module is configured to be connected to the physical interface through the anti-reverse module;
wherein the physical interface is configured to be connected to a physical interface of another battery pack in a battery system; wherein the detection module is configured to determine a voltage difference detection signal representing a voltage difference between the physical interface and the cell module; and
wherein the communication module is configured to send the voltage difference detection signal or receive a voltage difference detection signal detected by another battery pack or voltage difference detection signals detected by other battery packs, and the voltage difference detection signal is used to determine a series-parallel connection configuration of all the battery packs in the battery system.

10. The battery pack of claim 9, wherein the communication module is a wired communication module connected to the physical interface.

11. The battery pack of claim 9, further comprising a control module,
wherein the detection module comprises a proportional arithmetic unit and a sampling unit, wherein an input terminal of the proportional arithmetic unit is connected to the physical interface and the cell module and configured to output an output voltage signal according to a voltage difference between the physical interface and a positive terminal of the cell module or a negative terminal of the cell module; and
wherein an input terminal of the sampling unit is connected to an output terminal of the proportional arithmetic unit and configured to sample the output voltage signal and output the voltage difference detection signal to the control module.

12. The battery pack of claim 9, wherein the communication module is further configured to send device identification information of the battery pack comprising the communication module or receive device identification information of another battery pack.

13. The battery pack of claim 9, further comprising a protection module, wherein the cell module is connected to the anti-reverse module through the protection module.

14. The battery pack of claim 13, wherein the protection module comprises at least one of a fuse or a voltage follower.

15. The battery pack of claim 9, wherein the anti-reverse module comprises a diode, wherein a positive terminal of the diode is connected to the cell module, and a negative terminal of the diode is connected to the physical interface and the detection module separately.

16. A management method for a battery system, wherein the battery system comprises a control host and a plurality of battery packs electrically connected to each other, wherein each battery pack of the plurality of battery packs is communicatively connected to the control host;
each battery pack comprises a cell module, an anti-reverse module, a physical interface, and a detection module,
wherein the cell module is configured to be connected to the physical interface through the anti-reverse module, and the physical interfaces of the plurality of battery packs are connected to each other; and
wherein the detection module is configured to determine a voltage difference detection signal representing a voltage difference between the physical interface and the cell module; and
the method comprises:
acquiring the voltage difference detection signal of each battery pack; and
determining a series-parallel connection configuration of the plurality of battery packs in the battery system according to the voltage difference detection signal.

17. The management method for a battery system of claim 16, further comprising:
acquiring device identification information of each battery pack and outputting the series-parallel connection configuration of the plurality of battery packs in the battery system and the device identification information of each battery pack.

18. The management method for a battery system of claim 17, further comprising:
displaying graphical information representing the series-parallel connection configuration of the plurality of battery packs in the battery system and the device identification information of each battery pack on a display panel.
